(19) United States
(12) Patent Application Publication
(10) Pub. No.: US 2025/0202252 A1
(43) Pub. Date: Jun. 19, 2025

(54) INSTALL DEVICE AND CHARGING EQUIPMENT

(71) Applicants: Futaijing Precision Electronics (Yantai) Co., Ltd., Yantai (CN); HON HAI PRECISION INDUSTRY CO., LTD., New Taipei (TW)

(72) Inventor: HAN-CHUNG YU, New Taipei (TW)

(21) Appl. No.: 18/749,662

(22) Filed: Jun. 21, 2024

(30) Foreign Application Priority Data
Dec. 15, 2023 (CN) 202323431931.0

(51) Int. Cl. H02J 7/00; H01R 13/627; H01R 13/629; H01R 13/64; H01R 24/86

(52) U.S. Cl. CPC H02J 7/0042; H01R 13/6272; H01R 13/629; H01R 13/64; H01R 24/86

(57) ABSTRACT

The present application provides an install device and charging equipment. The install device comprises a fixing member, a connecting member, an install member and an elastic member. A matching hole is defined on the fixing member. The fixing member has a first side and a second side. The first side is fixed to a supporting part. The connecting member is fitted in the matching hole, and detachably connected to the fixing member. The install member comprises an install portion and a first rotating portion. One end of the install portion is arranged in the matching hole, the other end of the install portion is exposed to the fixing member. The first rotating portion is arranged on a side of the install portion received in the matching hole, and rotationally connected with the connecting member. The elastic member is flexibly connected between the connecting member and the install portion.

### FIELD

The present disclosure relates to field of charging equipment, and in particular to an install device and charging equipment.

### BACKGROUND

When an existing charging gun is not in use, the charging gun is usually stored in a charging gun holder. When the existing charging gun holder contains the charging gun, the charging gun will occupy a large space, and the charging gun is also easy to be collided by vehicles or pedestrians, resulting in damage to the charging gun holder, which makes an applicability of the charging gun holder poor and a service life of the charging gun holder low.

Thus, there is room for improvement within the art.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 shows a schematic diagram of an install device and an object member of the present application in an embodiment.

FIG. 2 shows a schematic diagram of an object member of the present application in an embodiment.

FIG. 3 shows a section view of the install device shown in FIG. 1, when the install device is loading into an object member of the present application in an embodiment.

FIG. 4 shows a section view of the install device shown in FIG. 1, when the install device is loaded into an object member of the present application in an embodiment.

FIG. 5 shows an explosive structure of the install device of the present application in an embodiment.

FIG. 6 shows an explosive structure of the install device of the present application in an embodiment.

FIG. 7 shows a section view of the install device of the present application in an embodiment.

FIG. 8 shows another section view of the install device of the present application in an embodiment.

### DETAILED DESCRIPTION

In order to make the above-mentioned objects, features and advantages of the present application more obvious, a detailed description of specific embodiments of the present application will be described in detail with reference to the accompanying drawings. A number of details are set forth in the following description so as to fully understand the present application. However, the present application can be implemented in many other ways different from those described herein, and those skilled in the art can make similar improvements without violating the contents of the present application. Therefore, the present application is not to be considered as limiting the scope of the embodiments described herein.

Several definitions that apply throughout this disclosure will now be presented.

The term “coupled” is defined as coupled, whether directly or indirectly through intervening components, and is not necessarily limited to physical connections. The connection may be such that the objects are permanently coupled or releasably coupled. The term “substantially” is defined to be essentially conforming to the particular dimension, shape, or other feature that the term modifies, such that the component need not have that exact feature. The term “comprising,” when utilized, means “including, but not necessarily limited to”; it specifically indicates open-ended inclusion or membership in the so-described combination, group, series, and the like.

Unless otherwise defined, all technical and scientific terms used herein have the same meaning as commonly understood by one skilled in the art. The terms used in a specification of the present application herein are only for describing specific embodiments and are not intended to limit the present application. The terms “and/or” used herein includes any and all combinations of one or more of associated listed items.

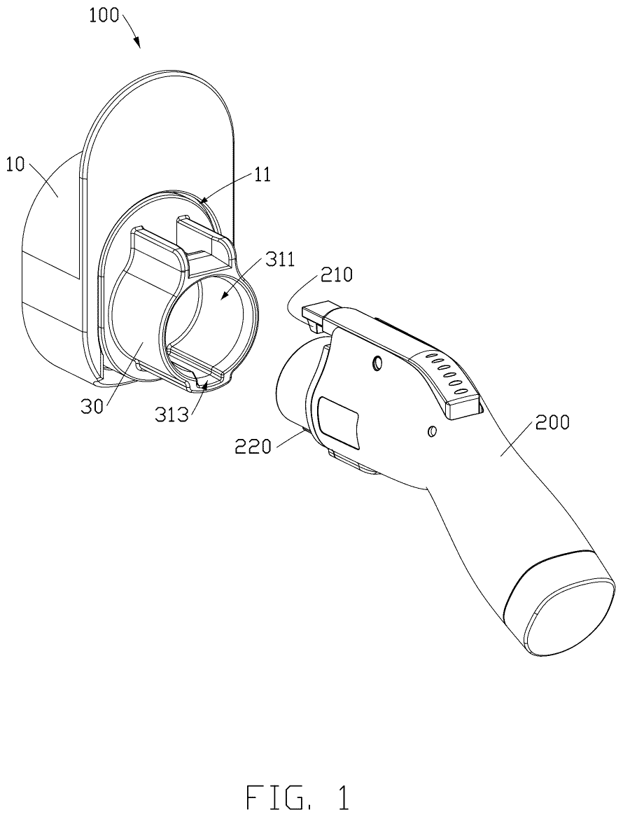

Referring to FIG. 1 to FIG. 3, in one embodiment, the charging equipment 300 includes a supporting part 301 and an install device 100. The supporting part 301 can be a mounting frame. The install device 100 is fixed on the supporting part 301, and the install device 100 is configured to install an object member 200. The object member 200 can be a charging gun, the charging gun can be connected to a power supply and configured to connect a rechargeable equipment, so that the charging gun charges the rechargeable equipment to be charged. In other embodiments, the object member 200 can also be other equipment to be installed, such as a refueling gun.

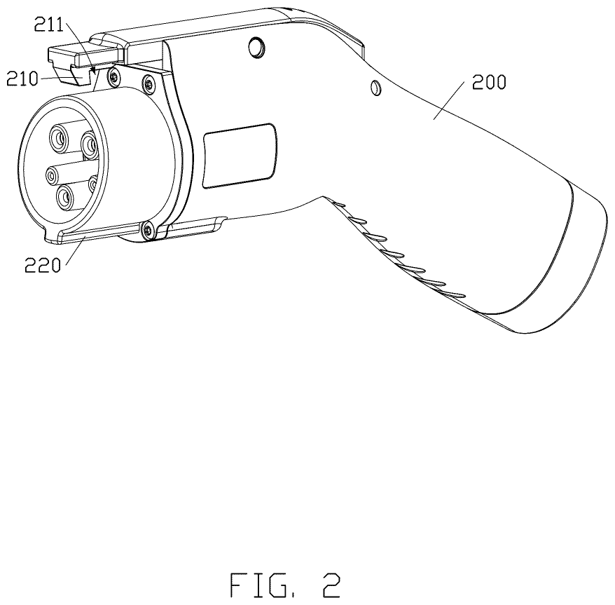

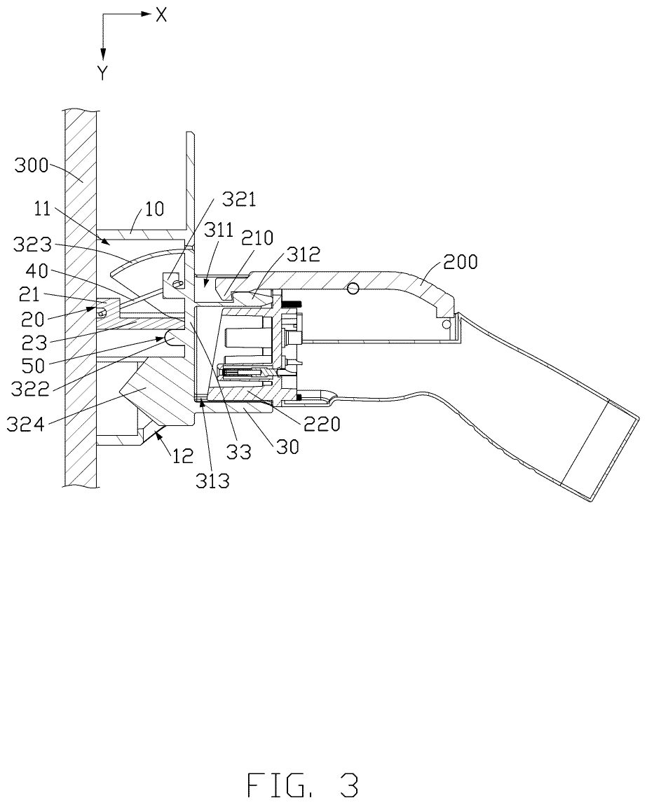

Referring to FIG. 2, in one embodiment, the object member 200 includes a connector portion 230 and a holding portion 240. The connector portion 230 and the holding portion 240 are connected to each other. An angle between the connector portion 230 and the holding portion 240 is obtuse. The connector portion 230 is configured for mounting the install member 30. As shown in FIG. 3, when the object member 200 is loaded into the install member 30, the connector portion 230 is horizontal. A part of the holding portion 240 away from the install device 100 in a first direction X is tilted downward in a second direction Z. An overall length of the object member 200 in the first direction X is larger and occupies more space.

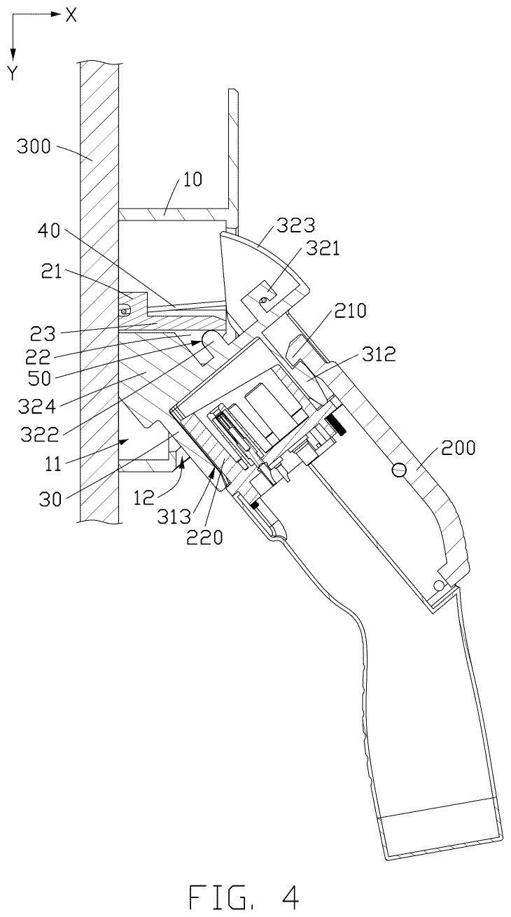

Referring to FIG. 3 to FIG. 4, in one embodiment, the install device 100 includes a fixing member 10, a connecting member 20, an install member 30, and an elastic member 40.

The fixing member 10 defines a matching hole 11. The fixing member 10 has a first side K1 and a second side K2, and along the first direction X, the first side K1 and the second side K2 are arranged opposite each other. The first side K1 is fixed to the supporting part 301. The connecting member 20 is fitted in the matching hole 11, and the connecting member 20 is detachable connected with the fixing member 10. The install member 30 includes a install portion 31 and a first rotating portion 322, one end of the install portion 31 is arranged in the matching hole 11, the other end of the install portion 31 is exposed in the fixing member 10 and is configured to install the object member 200. The first rotating part 322 is arranged on a side of the install portion 31 received in the matching hole 11. The first rotating part 322 is rotationally connected with the connecting member 20. The elastic member 40 is flexibly connected between the connecting member 20 and the install portion 31. The elastic member 40 is configured to drive the empty install member 30 abuts against an inner surface of the fixing part 10. After the install portion 31 installs the object member 200, the install portion 31 can overcome an elasticity of the elastic member 40 under a gravity of the object member 200, therefore the install portion 31 rotates the object member 200 relative to the connecting member 20 to a tilting state.

When the connector portion 230 of the object member 200 is installed after the install portion 31, the install portion 31 of the install member 30 is subjected to a gravity of the object member 200, the gravity of the object member 200 can overcome an elasticity of the elastic member 40, so that the first rotating portion 322 of the install member 30 and the connecting member 20 rotate relative to each other, and the object member 200 rotates to a tilting state shown in FIG. 4. As shown in FIG. 4, the connector portion 230 of the object member 200 is tilted, and the holding portion 240 is close to a vertical state, which greatly reduces a space occupied by the object member 200 in the first direction X, and reduces a possibility of collision damage to the object member 200 and the install device 100, and extends a service life of the object member 200 and the install device 100.

When the object member 200 is removed from the install member 30, an elasticity of the elastic member 40 can drive the install member 30 to rotate, and the elasticity of the elastic member 40 can make the install member 30 abut against an inner surface of the fixing member 10, thus facilitating a subsequent installation of the object member 200 and improving an ease of use of the install device 100.

Moreover, through a removable connection between the connecting member 20 and the fixing member 10, the first rotating portion 322 of the install member 30 can be rotationally connected with the connecting member 20. The fixing member 10, the connecting member 20 and the install member 30 can be reliably assembled through mechanical structures limit match, and the fixing member 10, the connecting member 20 and the install member 30 do not need to use screws to fix the connection. Thus, a rapid installation and a disassembly are realized, and an assembly convenience of the install device 100 is improved.

Referring to FIG. 3 to FIG. 4, in one embodiment, a bottom of the fixing member 10 defines an avoidance groove 12, the avoidance groove 12 is communicated with the matching hole 11. The avoidance groove 12 is configured for avoiding the install member 30, a bottom of the fixing member 10 also defines an abutting wall 16, the abutting wall 16 is configured to abut against the install member 30, so that the install member 30 is maintained in the second state.

When the install member 30 is installed with the object member 200, the install member 30 overcomes an elasticity of the elastic member 40 under a gravity of the object member 200, so that the install member 30 rotates relative to the connecting member 20. The avoidance groove 12 can avoid a bottom of the fixing member 10 from having a limiting effect on a rotation of the install member 30, so that the install member 30 rotates smoothly. In addition, when the install member 30 is moved into the avoidance groove 12, the avoidance groove 12 can also guide the rotation of the install member 30. The abutting wall 16 can also limit the rotation of the install member 30 to avoid a rotation angle of the install member 30 is too large and out of the fixing member 10, so as to ensure that the install member 30 is maintained in the second state.

Referring to FIG. 4 to FIG. 6, in one embodiment, in the first direction X, the fixing member 10 has a first side K1 and a second side K2 set relative to each other. An inner surface of the matching hole 11 defines a limiting groove 13, the limiting groove 13 extends in the first direction X. The limiting groove 13 defines an open mouth on the first side K1. The connecting member 20 includes a limit portion 25, the limit portion 25 can be fitted into the limiting groove 13 from an open mouth.

Thus, by loading the limit portion 25 into the limiting groove 13 from the open mouth, the limiting groove 13 can restrict the limit portion 25 to have only one freedom in the first direction X, so that a relative motion between the connecting member 20 and the fixing member 10 can only be generated in the first direction X. The install member 30 exerts a force on the connecting member 20 through the elastic member 40. The force makes the connecting member 20 close to the install member 30 along the first direction X, so that the limit portion 25 is kept abutting against an inner surface of the limiting groove 13, and a relative fixation of the connecting member 20 and the fixing member 10 is realized. When the connecting member 20 needs to be removed, the connecting member 20 can be removed from the first side K1 by overcoming an elasticity of the elastic member 40, making the install device 100 easy to disassemble.

In other embodiments, the limiting groove 13 may also define an open mouth on each of the first side K1 and the second side K2. The limit portion 25 provides a capping structure, in the first direction X, the capping structure is located at one end of the limit portion 25 away from the install member 30. The capping structure may be capped at the fixing member 10. The capping structure can also achieve a limiting effect between the connecting member 20 and the fixing member 10 to ensure a normal use of the install device 100. Therefore, there are many ways to realize a detachable connection between the connecting member 20 and the fixing member 10, which can be determined according to actual needs.

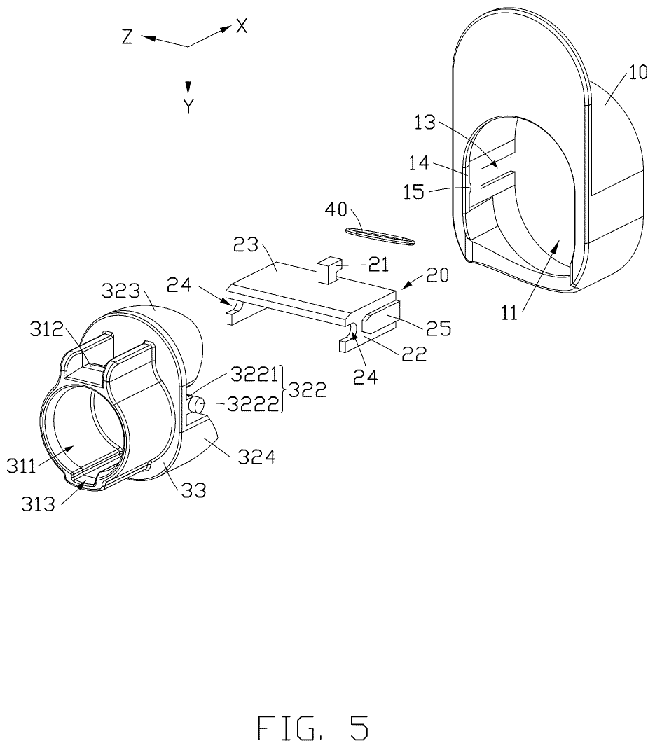

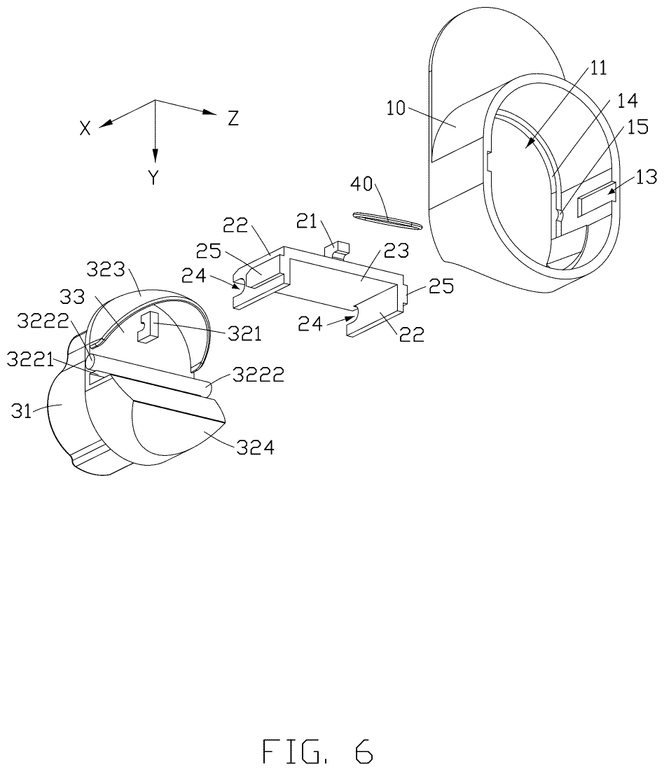

Referring to FIG. 5 to FIG. 6, in one embodiment, a number of the limiting grooves 13 is two, and a number of the limit portions 25 is two. The limiting groove 13 can be arranged on an inner surface of two sides of the matching hole 11 in the first direction X. The limit portion 25 is arranged on two sides of the connecting member 20 in the first direction X. By cooperating two limiting grooves 13 and two limit portions 25, a reliability of a matching between the connecting member 20 and the fixing member 10 can be improved. In other embodiments, the number of the limiting groove 13 and the number of the limit portion 25 may be three or more.

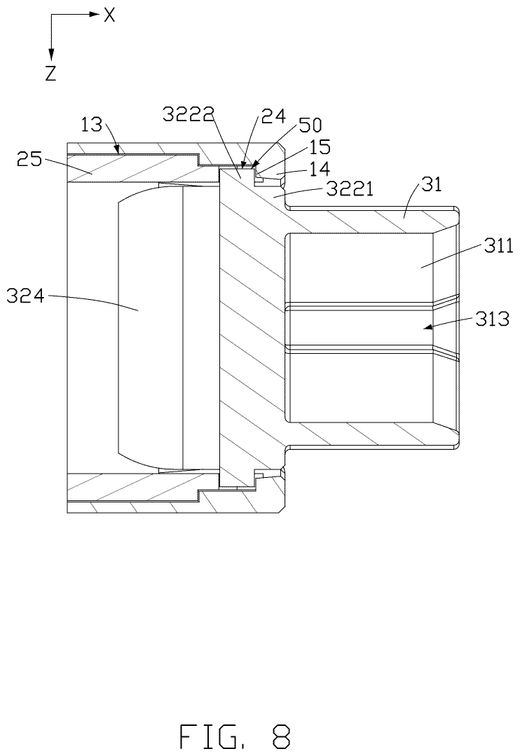

Referring to FIG. 6 to FIG. 8, in one embodiment, the connecting member 20 defines a rotating groove 24 formed by internal recessed, and the rotating groove 24 is located at one end of the connecting member 20 facing the second side K2. The first rotating portion 322 is rotationally fitted into the rotating groove 24. The connecting member 20 defines a rotating groove 24 formed by internal recessed, and the rotating groove 24 is located at one end of the connecting member 20 facing the second side K2. The second side K2 defines one or more stop portions 15, an opening of the rotating groove 24 is closed by one stop portion 15. A rotating space 50 is formed between the stop portion 15 and side walls of the rotating groove 24, the first rotating portion 322 is rotatably received in the rotating space 50.

When the connecting member 20 is loaded from the first side K1 of the fixing member 10 and the install member 30 is loaded from the second side K2, a rotating space 50 can be formed quickly. The first rotating portion 322 of the install member 30 is fitted into the rotating space 50, so as to realize a rotating coordination between the first rotating portion 322 and the fixing member 10. Therefore, under a structural design of a removable connection of the fixing member 10, the install member 30 and the connecting member 20, a reliable pivot connection between the install member 30 and the fixing member 10 can still be realized, and the object member 200 can drive the install member 30 to rotate relative to the fixing member 10.

In other embodiments, the rotating groove 24 may also be arranged at the install member 30, the stop portion 15 is arranged at the connecting member 20. A structure of the rotating space 50 surrounded by the connecting member 20 and the fixing member 10 may be arranged in a variety of ways, which are not specified in this embodiment.

Optionally, the rotating groove 24 includes a semicircular arc. One side of the first rotating portion 322 fits within the semicircular arc, and another one side of the first rotating portion 322 is tangent to the stop portion 15. Therefore, a friction during a rotation of the first rotating portion 322 can be reduced, and a wear caused by a rotation of the install member 30 after the installation of the object member 200 can be reduced, so as to improve a service life of the install device 100. When the object member 200 is removed from the install member 30, this structure reduces a resistance of the install member 30 to rotation under a force of the elastic member 40, so that the install member 30 quickly returns to a horizontal state.

Referring to FIG. 5 to FIG. 6, in one embodiment, the connecting member 20 includes a top wall 23 and two side walls 22. The two side walls 22 are respectively connected to the top wall 23 on either side in the second direction Z.

In one embodiment, each of the two side walls 22 defines a rotating groove 24 in the first direction X. The rotating groove 24 is located at one end of the side wall 22 towards the second side K2. The first rotating portion 322 includes a protruding portion 3221 and two second rotating portions 3222. The protruding portion 3221 is arranged between the two side walls 22. In the second direction Z, two second rotating portions 3222 are arranged at each end of the protruding portion 3221, and the two second rotating portions 3222 are fitted into two rotating grooves 24. A number of the stop portions 15 is two. In the second direction Z, the two stop portions 15 are respectively arranged on two opposite side surfaces of the matching hole 11. The two stop portions 15 are respectively connected to the two second rotating portions 3222.

Through a setting of two second rotating portions 3222, a pivot fit between the first rotating portion 322 and the fixing member 10 can be more stable and reliable. Moreover, since the second rotating portion 3222 is processed between two ends of the protruding portion 3221, a processing difficulty of the first rotating portion 322 can be reduced. The second rotating portion 3222 can be formed into a complete cylinder to avoid a possibility of an interference between the install member 30 and the connecting member 20 during a rotation of the first rotating portion 322. In addition, the rotating groove 24 is set at the two side walls 22, which can save a material cost and reduce a processing difficulty of the connecting member 20.

In addition, in one embodiment, referring to FIG. 3, when the install member 30 is in the first state, the protruding portion 3221 touches a lower surface of the connecting member 20, which also has an effect of keeping install member 30 in the first state.

When assembling the install device 100 of one embodiment, the connecting member 20 and the install member 30 are connected by the elastic member 40, and the first rotating portion 322 is fitted into the rotating groove 24. Then, a structure is simultaneously loaded into the matching hole 11 from the second side K2, and the limit portion 25 is slipped and fitted with the limiting groove 13. Then, under an action of an elastic force of the elastic member 40, the limit portion 25 is maintained in a state of the fixing member 10.

The rotating groove 24 is matched with the stop portion 15 to form a rotating space 50, so as to limit the second rotating portion 3222, and finally complete an assembly of the install device 100.

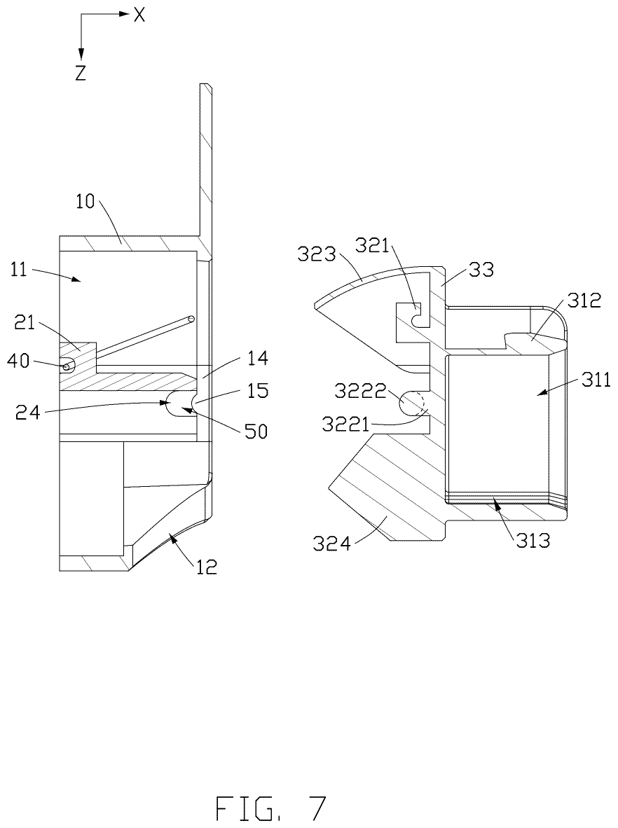

Referring to FIG. 6 to FIG. 7, in one embodiment, the fixing member 10 further includes a strengthening portion 14, the strengthening portion 14 is convex to an inner surface of the matching hole 11 in the second direction Z. In the first direction X, the stop portion 15 is arranged on a surface of the strengthening portion 14 towards the first side

K1, and the stop portion 15 abuts against the second rotating portion 3222.

The stop portion 15 includes a main body and a contact portion. The main body is convex on an inner surface of the matching hole 11 in the second direction Z. In the first direction X, the contact portion is arranged on an inner surface of the main body towards the first side K1, and the contact portion is connected to the second rotating portion 3222.

Therefore, the stop portion 15 abuts against the second rotating portion 3222 in the first direction X, and the stop portion 15 can strengthen a connection strength between the contact portion and the fixing member 10. Thereby, the above structural designs can improve a stop effect of the stop portion 15 and greatly reduce a possibility of the stop portion 15 breaking with the fixing member 10 under a gravity of the object member 200, which extends a service life of the install device 100.

Referring to FIG. 5 to FIG. 6, in one embodiment, the connecting member 20 defines a first connection portion 21, and the install member 30 further includes a second connection portion 321. In the first direction X, the second connection portion 321 is arranged on a side of the install portion 31 towards the connecting member 20, and the elastic member 40 is connected between the first connection portion 21 and the second connection portion 321.

Referring to FIG. 5 and FIG. 6, the first connection portion 21 is arranged at the top wall 23 of the connecting member 20.

Optionally, each of the first connection portion 21 and the second connection portion 321 can be a card hook. Each of two card hooks defines a card slot. Two card slots of the two card hooks are arranged on an opposite side. Two ends of the elastic member 40 are respectively connected to the two card hooks. Therefore, a detachable connection between the elastic member 40 and the two card hooks can be achieved. In one embodiment, the elastic member 40 may be an elastic ring. The elastic ring is arranged between the two card hooks. In other embodiments, the elastic member 40 may also be a tension spring, an elastic sleeve, etc.

Referring to FIG. 3 to FIG. 4, in one embodiment, the install member 30 further includes an abutting portion 324, the abutting portion 324 is arranged on a side of the install portion 31 towards the connecting member 20. The abutting portion 324 is arranged on a side of the first rotating portion 322 away from the connecting member 20.

The install member 30 can be rotated relative to the connecting member 20 to a lower surface of the abutting portion 324, the abutting portion 324 abuts against the lower surface of the connecting member 20. The abutting portion 324 can limit a rotation angle range of the install member 30 relative to the fixing member 10, so as to avoid the rotation angle of the install member 30 is too large and reverse, which improves a reliability of the install device 100.

Referring to FIG. 3 to FIG. 4, in one embodiment, install member 30 further includes a protective shell 323. The protective shell 323 is arranged on a side of the install portion 31 facing the connecting member 20. In a third direction Y, the protective shell 323 and the abutting portion 324 are arranged at intervals. The protective shell 323 is configured to close a part of the matching hole 11. The second connecting portion 321 is located inside the protective shell 323. The protective shell 323 can protect an inner surface of the matching hole 11 and the second connection portion 321, thereby protecting the elastic member 40, thereby reducing a possibility of the elastic member 40 being separated from the first connection portion 21 and the second connection portion 321 under external forces, thus ensuring a reliability of the install device 100.

Referring to FIG. 3 to FIG. 4, in one embodiment, a surface of the object member 200 defines a first locking portion 210. A second locking portion 312 is defined on a surface of the install portion 31. The second locking portion 312 is configured for connection with the first locking portion 210 of the object member 200 installed in the install portion 31, thereby locking the object member 200 in the install portion 31 in the first direction X. By setting the first locking portion 210 and the second locking portion 312, the object member 200 can be stably fixed on the install portion 30, so as to avoid the object member 200 falling off from the install portion 30, and thus ensure an installation reliability of the object member 200 on the install device 100.

In one embodiment, the first locking portion 210 and the second locking portion 312 may be clasps. Two clasps are clasped to each other in the first direction X, thereby limiting a degree of freedom of the object member 200 relative to the install member 30 in the first direction X.

Referring to FIG. 3 to FIG. 4, in one embodiment, the install portion 31 defines an inserting hole 311. The inserting hole 311 is configured for loading the object member 200. The object member 200 defines a positioning portion 220. An inner surface of the inserting hole 311 defines a positioning slot 313. The positioning slot 313 is configured for sliding the positioning portion 220 into and positioning the object member 200 in a circumferential direction of the inserting hole 311. By combining the positioning slot 313 with the positioning portion 220, the object member 200 is relatively fixed to the install member 30 in a circumferential direction of the inserting hole 311, thus improving an installation reliability of the object member 200 on the install member 30.

In other embodiments, a positioning portion 220 is defined on an inner surface of the inserting hole 311. A surface of the object member 200 defines a positioning slot 313. Locations of the positioning slot 313 and the positioning portion 220 may be determined according to actual needs.

In one embodiment, a length direction of the positioning slot 313 is parallel to the first direction X, so that the object member 200 has only one degree of freedom in the first direction X. The first locking portion 210 and the second locking portion 312 cooperate to limit a freedom of the object member 200 along the first direction X, so that the object member 200 can be completely fixed on the install member 30, thus ensuring a installation reliability of the object member 200.

In one embodiment, the first direction X, the second direction Z, and the third direction Y are arranged in pairs at an included angle. Further, the first direction X, the second direction Z, and the third direction Y are perpendicular in pairs.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. An install device for a charging device, comprising:
a fixing member, a matching hole is defined on the fixing member;
a connecting member, fitted in the matching hole, and the connecting member is detachably connected to the fixing member;
an install member, comprising an install portion and a first rotating portion, wherein one end of the install portion is arranged in the matching hole, the other end of the install portion is exposed to the fixing member, and the other end of the install portion is configured to install an object member, the first rotating portion is arranged on a side of the install portion received in the matching hole, and the first rotating portion is rotationally connected with the connecting member, the install member has a first state and a second state; and
an elastic member, flexibly connected between the connecting member and the install portion, and configured to exert an elastic force on the install member to keep the install member in the first state, wherein after the object member is loaded into the install member, the install member is configured to overcome the elastic force under a gravity of the object member and rotates to the second state.

2. The install device as claimed in claim 1, wherein, a bottom of the fixing member defines an avoidance groove, the avoidance groove is configured to avoid the connecting member, the bottom of the fixing member also defines an abutting wall, the abutting wall abuts against the connecting member to keep the connecting member in the second state.

3. The install device as claimed in claim 1, wherein, the fixing member has a first side and a second side, and the first side and the second side are opposite to each other in a first direction; an inner surface of the matching hole defines a limiting groove, the limiting groove extends along the first direction, and the limiting groove defines an open mouth on the first side; the connecting member comprises a limit portion, the limit portion can be inserted into the limiting groove from the open mouth.

4. The install device as claimed in claim 1, wherein, the fixing member has a first side and a second side, and the first side and the second side are opposite to each other in a first direction; one end of the connecting member toward the second side defines a rotating groove, the second side defines one or more stop portions, an opening of the rotating groove is closed by one stop portion, a rotating space is formed between the stop portion and side walls of the rotating groove, the first rotating portion is rotatably received in the rotating space.

5. The install device as claimed in claim 4, wherein, the connecting member comprises two side walls, the two side walls are arranged at intervals along a second direction, and along the first direction, one end of each side wall of the two side walls toward the second side is respectively provided with the rotating groove; the first rotating portion comprises a protruding portion and two second rotating portions, the protruding portion is located between the two side walls, and along the second direction, the two second rotating portions are respectively arranged at two ends of the protruding portion, and the two second rotating portions are respectively matched in the two rotating grooves; the stop portion is provided with two, and along the second direction, two stop portions are respectively arranged on two opposite side surfaces of the matching hole, and the two stop portions are respectively connected with the two second rotating portions.

6. The install device as claimed in claim 1, wherein, the connecting member is provided with a first connecting portion, the fixing member further comprises a second connecting portion, along the first direction, the second connecting portion is arranged on a side of the install portion toward the connecting member, the elastic member is connected between the first connecting portion and the second connecting portion.

7. The install device as claimed in claim 1, wherein, the install member further comprises a abutting portion, the abutting portion is arranged on a side of the install portion toward the connecting member, and the abutting portion is located on a side of the rotating portion away from the connecting member, and the install member is capable of rotating relative to the connecting member to a lower surface of the abutting portion, the abutting portion abuts against the lower surface of the connecting member.

8. The install device as claimed in claim 1, wherein, a surface of the object member is provided with a first locking portion; a surface of the install portion is provided with a second locking portion, when the object member is loaded into the install portion, the second locking portion is configured to connect with the first locking portion of the object member to lock the object member in the install portion in the first direction.

9. The install device as claimed in claim 8, wherein, the install portion defines a inserting hole, and the inserting hole is configured for loading the object member; the object member is provided with a positioning portion, and an inner surface of the inserting hole defines a positioning slot, and the positioning slot is configured to receive the positioning portion, to locate the object member in a circumferential direction of the inserting hole.

10. A charging equipment, comprising:
a supporting part,
an install device for a charging device, comprising:
a fixing member, a matching hole is defined on the fixing member, the fixing member is fixed to the supporting part;
a connecting member, fitted in the matching hole, and the connecting member is detachably connected to the fixing member;
an install member, comprising an install portion and a first rotating portion, wherein one end of the install portion is arranged in the matching hole, the other end of the install portion is exposed to the fixing member, and the other end of the install portion is configured to install an object member, the first rotating portion is arranged on a side of the install portion received in the matching hole, and the first rotating portion is rotationally connected with the connecting member, the install member has a first state and a second state; and
an elastic member, flexibly connected between the connecting member and the install portion, and configured to exert an elastic force on the install member to keep the install member in the first state, wherein after the object member is loaded into the install member, the install member is configured to overcome the elastic force under a gravity of the object member and rotates to the second state.

11. The charging equipment as claimed in claim 10, wherein, a bottom of the fixing member defines an avoidance groove, the avoidance groove is configured to avoid the connecting member, the bottom of the fixing member is also provided with a abutting wall, the abutting wall abuts against the connecting member to keep the connecting member in the second state.

12. The charging equipment as claimed in claim 10, wherein, the fixing member has a first side and a second side, and the first side and the second side are opposite to each other in a first direction; an inner surface of the matching hole defines a limiting groove, the limiting groove extends along the first direction, and the limiting groove defines an open mouth on the first side; the connecting member comprises a limit portion, the limit portion can be inserted into the limiting groove from the open mouth.

13. The charging equipment as claimed in claim 10, wherein, the fixing member has a first side and a second side, and the first side and the second side are opposite to each other in a first direction; one end of the connecting member toward the second side defines a rotating groove formed by an internal concave, the second side defines one or more stop portions, an opening of the rotating groove is closed by one stop portion, a rotating space is formed between the stop portion and side walls of the rotating groove, the first rotating portion is rotatably received in the rotating space.

14. The charging equipment as claimed in claim 13, wherein, the connecting member comprises two side walls, the two side walls are arranged at intervals along a second direction, and along the first direction, one end of each side wall of the two side walls toward the second side is respectively provided with the rotating groove; the first rotating portion comprises a protruding portion and two second rotating portions, the protruding portion is located between the two side walls, and along the second direction, the two second rotating portions are respectively arranged at two ends of the protruding portion, and the two second rotating portions are respectively matched in the two rotating grooves; the stop portion is provided with two, and along the second direction, two stop portions are respectively arranged on two opposite side surfaces of the matching hole, and the two stop portions are respectively connected with the two second rotating portions.

15. The charging equipment as claimed in claim 10, wherein, the connecting member is provided with a first connecting portion, the fixing member further comprises a second connecting portion, along the first direction, the second connecting portion is arranged on a side of the install portion toward the connecting member, the elastic member is connected between the first connecting portion and the second connecting portion.

16. The charging equipment as claimed in claim 10, wherein, the install member further comprises a abutting portion, the abutting portion is arranged on a side of the install portion toward the connecting member, and the abutting portion is located on a side of the rotating portion away from the connecting member, and the install member is capable of rotating relative to the connecting member to a lower surface of the abutting portion, the abutting portion abuts against the lower surface of the connecting member.

17. The charging equipment as claimed in claim 10, wherein, a surface of the object member is provided with a first locking portion; a surface of the install portion is provided with a second locking portion, when the object member is loaded into the install portion, the second locking portion is configured to connect with the first locking portion of the object member to lock the object member in the install portion in the first direction.

18. The charging equipment as claimed in claim 10, wherein, the install portion defines a inserting hole, and the inserting hole is configured for loading the object member; the object member is provided with a positioning portion, and an inner surface of the inserting hole defines a positioning slot, and the positioning slot is configured to receive the positioning portion, to locate the object member in a circumferential direction of the inserting hole.
